(19) United States
(12) Patent Application Publication
(10) Pub. No.: US 2004/0228334 A1
(43) Pub. Date: Nov. 18, 2004

(54) Apparatus and method for network telephony

(76) Inventors: Weihai Pan, Shenzhen (CN); Mingwu Jiang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/830,241

(22) Filed: Apr. 22, 2004

(30) Foreign Application Priority Data
May 16, 2003 (TW) 92113406

(51) Int. Cl. H04L 12/66

(52) U.S. Cl. 370/352; 370/401

(57) ABSTRACT

A telephony apparatus (10) for communication over a network (300) includes a user interface module for collecting audio input and broadcasting audio signals, a converter (110) for converting digital signals into audio signals, an Internet protocol (IP) module (130) for packing digital signals into IP packets, a network interface module (140) connected with the IP module for providing a communication interface between the telephony apparatus and the network, and a protocol/signaling controlling module (150) connected with the converter and the IP module for exchanging communication protocols/signalings. The converter is connected with the user interface module, and also converts audio signals into digital signals. The IP module also unpacks IP packets into digital signals. A related method for telephonic communication over a network between a calling telephony apparatus and a called telephony apparatus is also provided.

### BACKGROUND OF THE INVENTION

1. Field of the Invention

The present invention relates to a telephonic communication system, and more particularly to an apparatus and method for computer network telephony.

2. Description of Related Art

Conventional network telephone communication is developed on the basis of an IP (Internet Protocol) network. A conventional network telephone system employs a normal fixed-line type of telephone set as a terminal. A service gateway converts audio signals transmitted from the normal telephone into IP packets, which are then transmitted over the IP network. Since the IP packets need not monopolize a particular communication channel, the cost of a long-distance telephone call using the network telephone system is greatly reduced.

However, the service gateway is generally provided by a telecommunication service provider. The telecommunication service provider charges the subscribers for the service gateway. As a result, the cost of a short-distance telephone call using the network telephone system may be higher than the cost of making the same call using a normal telephone line. That is, the low-cost advantages of the network telephone system are generally limited to long-distance calls, and exclude short-distance calls. In addition, the service gateway may have to deal with a vast number of active subscribers during peak periods. At such times, the service gateway is liable to switch to a busy status, in which it is not able to cope with more call requirements. Newly active subscribers are made to

Consequently, what is needed is an apparatus and method for network telephony that can convert the audio signals into the IP packets without the need for a service gateway.

### SUMMARY OF THE INVENTION

Accordingly, a primary object of the present invention is to provide a telephony apparatus for reliable and low-cost communication over a network.

Another object of the present invention is to provide a telephony method for reliable and low-cost communication over a network.

In order to fulfill the above-mentioned primary object, the present invention provides a telephony apparatus for communication over a network. The telephony apparatus comprises a user interface module for collecting audio input and broadcasting audio signals, a converter for converting digital signals into audio signals, an IP module for packing the digital signals into IP packets, a network interface module connected with the IP module for providing a communication interface between the telephony apparatus and the network, and a protocol/signaling controlling module connected with the converter and the IP module for exchanging communication protocols/signalings. The converter is connected with the user interface module, and also converts audio signals into digital signals. The IP module also unpacks IP packets into digital signals.

In order to fulfill the other above-mentioned object, the present invention provides a method for telephonic communication over a network between a calling telephony apparatus and a called telephony apparatus. The method comprises the following steps: (a) transmitting a number of the called telephony apparatus to an IP module; (b) packing the number of the called telephony apparatus into an IP packet; (c) transmitting the IP packet to a call manager; (d) returning an IP address of the called telephony apparatus; and (e) communicating with the called telephony apparatus in a duplex manner.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic diagram of an application environment of a network telephone according to the present invention;

FIG. 2 is a schematic diagram of hardware infrastructure of the network telephone according to the present invention;

FIG. 3 is a schematic diagram of exemplary communication between two network telephones according to the present invention; and

FIG. 4 is a flow chart of an exemplary method for communicating between two network telephones according to the present invention.

### DETAILED DESCRIPTION OF THE INVENTION

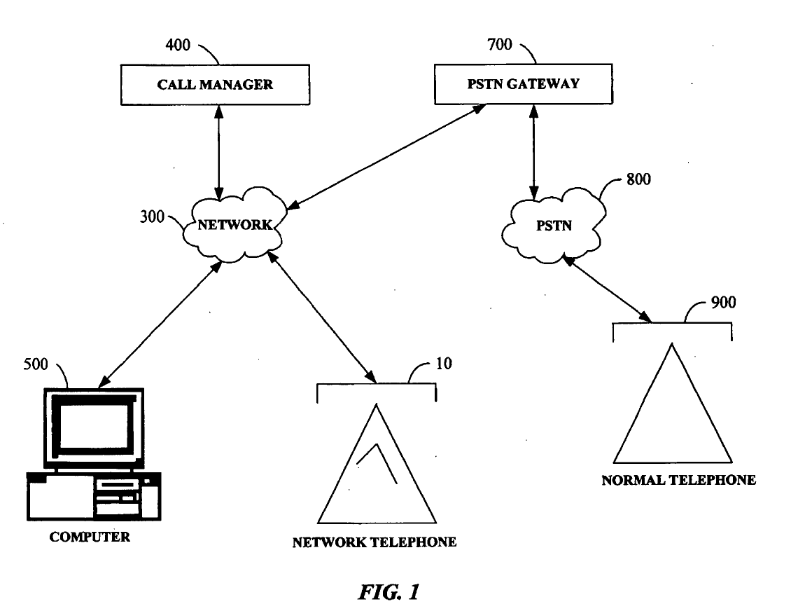

FIG. 1 is a schematic diagram of an application environment of a network telephone 10 according to the present invention. The network telephone 10 is coupled to a network 300. The network 300 of the exemplary embodiment may be an asynchronous transfer mode (ATM) network, an Ethernet, or an IP network. The network 300 communicates with a call manager 400 and a public switched telephone network (PSTN) gateway 700 in a duplex manner. The call manager 400 is provided for dealing with call requirements from the network telephone 10. A normal fixed-line type of telephone set 900 communicates with the PSTN gateway 700 by way of a PSTN 800. The network telephone 10 and any other device such as a computer 500 communicate with the normal telephone 900 through the network 300, the PSTN gateway 700 and the PSTN 800.

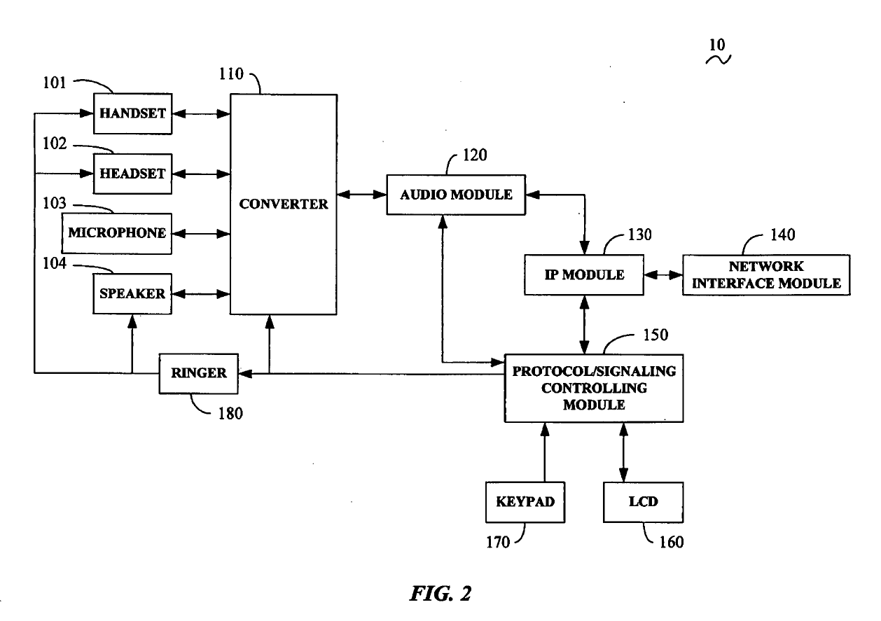

FIG. 2 is a schematic diagram of hardware infrastructure of the network telephone 10 according to the present invention. The network telephone 10 comprises a handset 101 for collecting audio input and broadcasting audio signals, a headset 102 for collecting audio input and broadcasting audio signals, a microphone 103 for collecting audio input, a speaker 104 for broadcasting audio signals, a converter 110, an audio module 120, an IP module 130, a network interface module 140, a protocol/signaling controlling module 150, a liquid crystal display (LCD) 160, a keypad 170, and a ringer 180.

The ringer 180 is coupled to the handset 101, the headset 102 and the speaker 104, and is used for generating audio output such as a ringing tone, a dialing tone and a busy tone. The audio module 120 is connected with the converter 110, and is for compressing/decompressing digital signals by using a digital signal processing (DSP) chip. The network interface module 140 is connected with the IP module 130, and provides a communication interface between the network telephone 10 and the network 300 (see FIG. 1). The protocol/signaling controlling module 150 is connected with the converter 110, the audio module 120, the IP module 130 and the ringer 180. The protocol/signaling controlling module 150 exchanges communication protocols/signalings with a called or calling party, such as the normal telephone 900 of FIG. 1 or another network telephone. The LCD 160 is connected with the protocol/signaling controlling module 150, and displays a calling/called telephone number. The keypad 170 is connected with the protocol/signaling controlling module 150, and is provided for dialing and encrypting.

The converter 110 is connected with the handset 101, the headset 102, the microphone 103 and the speaker 104. The converter 110 is for converting digital signals from the network 300 into audio signals, and transmitting the audio signals to the handset 101, the headset 102, or the speaker 104. The converter 110 is also used for converting audio signals from the handset 101, the headset 102 or the microphone 103 into digital signals, and transmitting the digital signals to the network 300. The IP module 130 is connected with the audio module 120. The IP module 130 is for packing digital signals compressed by the audio module 120 into IP packets, and transmitting the IP packets to the network interface module 140. The IP module 130 is also used for unpacking IP packets transmitted by the network interface module 140 into digital signals, and transmitting the digital signals to the audio module 120.

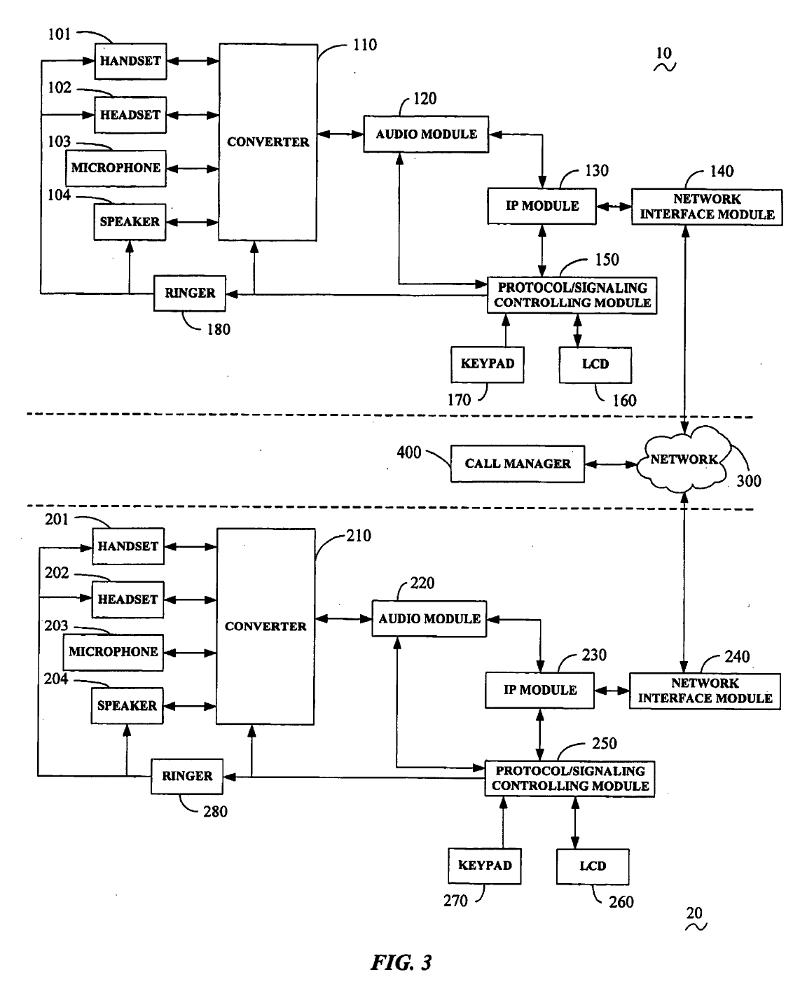

FIG. 3 is a schematic diagram of exemplary communication between the network telephone 10 and a network telephone 20 according to the present invention. The network telephone 20 has a same configuration as the network telephone 10. When a calling subscriber (not shown) calls the network telephone 20 by using the network telephone 10, he/she picks up the handset 101 or the headset 102, or uses the microphone 103. The ringer 180 generates a dialing tone, and then transmits it to the handset 101, the headset 102 or the speaker 104. The calling subscriber dials a number of the network telephone 20 via the keypad 170. Simultaneously, the LCD 160 displays the number of the network telephone 20. The number of the network telephone 20 is transmitted from the keypad 170 to the IP module 130 by way of the protocol/signaling controlling module 150. The IP module 130 packs the number of the network telephone 20 into an IP packet, and then transmits the IP packet to the call manager 400 by way of the network interface module 140 and the network 300. The call manager 400 returns an IP address of the network telephone 20 to the network telephone 10. According to the IP address, the network telephone 10 communicates with the network telephone 20 through the network interface module 140, the network 300 and a network interface module 240.

At that time, the protocol/signaling controlling module 150 of the network telephone 10 exchanges communication protocols/signalings with a protocol/signaling controlling module 250 of the network telephone 20. If the network telephone 20 is busy, it transmits a message to notify the network telephone 10 that it is busy. According to the message, the ringer 180 generates a busy tone, and then transmits it to the handset 101, the headset 102 or the speaker 104. If the network telephone 20 is free, the network telephone 10 determines a standard for compressing/decompressing digital signals with the network telephone 20. The standard may be the international telecommunications union telecommunication standardization sector (ITU-T) G.711 standard, the ITU-T G.723 standard, or the ITU-T G.729 standard. Subsequently, a ringer 280 generates a ringing tone, and then transmits it to a speaker 204. The speaker 204 broadcasts the ringing tone. Simultaneously, an LCD 260 displays a number of the network telephone 10. Hearing the ringing tone, a called subscriber (not shown) can answer the call by using a handset 201, a headset 202 or a microphone 203. The audio signals of the called subscriber are transmitted to the network telephone 10 through a converter 210, an audio module 220 and an IP module 230. The communication between the network telephone 10 and the network telephone 20 is in a duplex manner. In addition, like the network telephone 10, the network telephone 20 has a keypad 270 for dialing and encrypting.

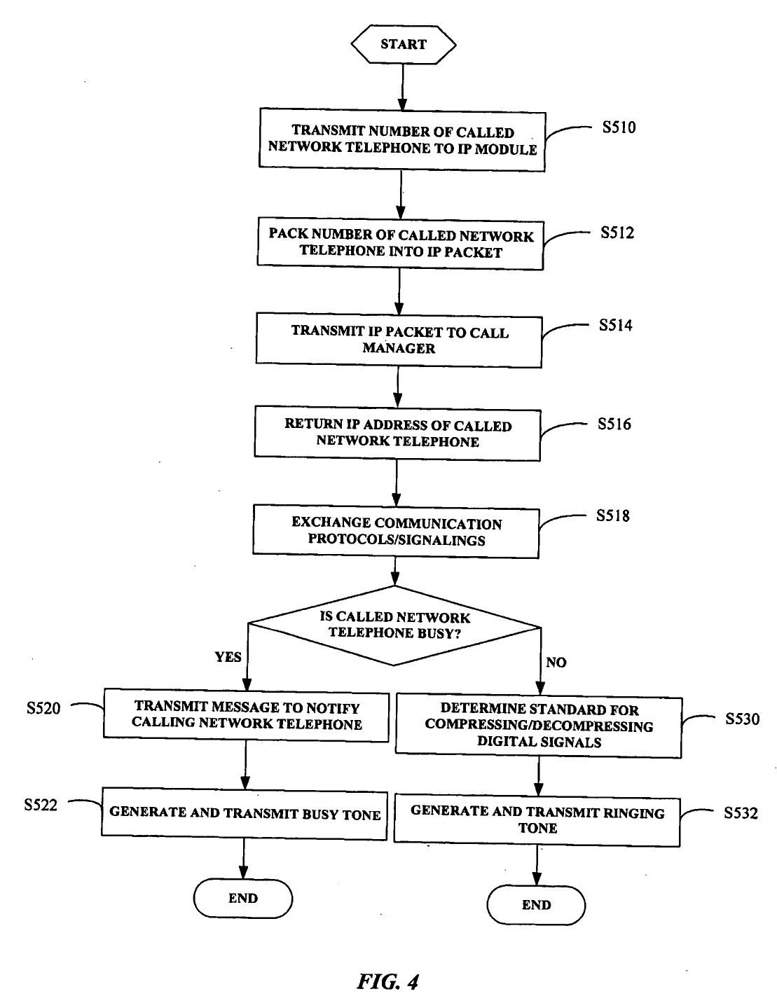

FIG. 4 is a flow chart of an exemplary method for communicating between the calling network telephone 10 and the called network telephone 20 according to the present invention. At step S510, after the calling subscriber dials a number of the called network telephone 20 via the keypad 170, the number of the called network telephone 20 is transmitted from the keypad 170 to the IP module 130 by way of the protocol/signaling controlling module 150. At step S512, the IP module 130 packs the number of the called network telephone 20 into an IP packet. At step S514, the IP module 130 transmits the IP packet to the call manager 400 by way of the network interface module 140 and the network 300. At step S516, the call manager 400 returns an IP address of the called network telephone 20 to the calling network telephone 10. At step S518, according to the IP address, the protocol/signaling controlling module 150 of the calling network telephone 10 exchanges communication protocols/signalings with the protocol/signaling controlling module 250 of the called network telephone 20. If the called network telephone 20 is busy, the procedure goes to step S520. Otherwise, the procedure goes to step S530. At step S520, the called network telephone 20 transmits a message to notify the calling network telephone 10 that it is busy. At step S522, in response to the message, the ringer 180 generates a busy tone, and then transmits the busy tone to the handset 101, the headset 102 or the speaker 104. At step S530, the calling network telephone 10 determines a standard for compressing/decompressing digital signals with the called network telephone 20. At step S532, the ringer 280 generates a ringing tone, and then transmits the ringing tone to the speaker 204. The speaker 204 broadcasts the ringing tone to notify the called subscriber.

While a preferred embodiment and preferred method of the present invention have been described above, it should be understood that they have been presented by way of example only and not by way of limitation. Thus the breadth and scope of the present invention should not be limited by the above-described exemplary embodiment and method, but should be defined only in accordance with the following claims and their equivalents.

What is claimed is:

1. A telephony apparatus for communication over a network, the telephony apparatus comprising:
a user interface module for collecting audio input and broadcasting audio signals;
a converter connected with the user interface module, for converting digitals signal into audio signals, and for converting audio signals into digital signals;
an Internet protocol (IP) module for packing digital signals into IP packets, and unpacking IP packets into digital signals;
a network interface module connected with the IP module, for providing a communication interface between the telephony apparatus and the network; and
a protocol/signaling controlling module connected with the converter and the IP module, for exchanging communication protocols/signalings.

2. The telephony apparatus as claimed in claim 1, further comprising an audio module connected with the converter, the IP module and the protocol/signaling controlling module, for compressing/decompressing digital signals.

3. The telephony apparatus as claimed in claim 1, further comprising a ringer coupled to the user interface module and the protocol/signaling controlling module, for generating audio signals.

4. The telephony apparatus as claimed in claim 3, wherein the audio signals comprise a ringing tone, a dialing tone and a busy tone.

5. The telephony apparatus as claimed in claim 1, further comprising a display connected with the protocol/signaling controlling module, for displaying calling/called telephone numbers.

6. The telephony apparatus as claimed in claim 5, wherein the display is a liquid crystal display.

7. The telephony apparatus as claimed in claim 1, further comprising a keypad connected with the protocol/signaling controlling module for dialing and encrypting.

8. The telephony apparatus as claimed in claim 1, wherein the user interface module comprises a handset for collecting audio input and broadcasting audio signals.

9. The telephony apparatus as claimed in claim 1, wherein the user interface module comprises a headset for collecting audio input and broadcasting audio signals.

10. The telephony apparatus as claimed in claim 1, wherein the user interface module comprises a microphone for collecting audio input, and a speaker for broadcasting audio signals.

11. A method for telephonic communication over a network between a calling telephony apparatus and a called telephony apparatus, the telephony method comprising the following steps:
(a) transmitting a number of the called telephony apparatus to an Internet protocol (IP) module;
(b) packing the number of the called telephony apparatus into an IP packet;
(c) transmitting the IP packet to a call manager;
(d) returning an IP address of the called telephony apparatus; and
(e) communicating with the called telephony apparatus in a duplex manner.

12. The method as claimed in claim 11, wherein step (e) comprises the following steps:
(e1) exchanging communication protocols/signalings with the called telephony apparatus;
(e2) generating a busy tone if the called telephony apparatus is busy; and
(e3) determining a standard for compressing/decompressing digital signals if the called telephony apparatus is free.

13. A telephony apparatus for communication over a network, the telephony apparatus comprising:
a converter for converting digitals signal into audio signals, and for converting audio signals into digital signals;
an Internet protocol (IP) module for packing digital signals into IP packets, and unpacking IP packets into digital signals;
a network interface module connected with the IP module, for providing a communication interface between the telephony apparatus and the network;
a protocol/signaling controlling module connected with the converter and the IP module, for exchanging communication protocols/signalings; and
an audio module respectively connected to the IP module, the converter and the protocol/signaling controlling module.
